(19) United States
(12) Patent Application Publication
(10) Pub. No.: US 2014/0339052 A1
(43) Pub. Date: Nov. 20, 2014

(54) APPARATUS FOR TRANSPORTING, OR FOR TRANSPORTING AND FOR PROCESSING, PRINTED CIRCUIT BOARDS

(71) Applicant: Pematech AG, Radolfzell (DE)

(72) Inventor: Alf MUELLER, Bodman-Ludwigshafen (DE)

(73) Assignee: Pematech AG, Radolfzell (DE)

(21) Appl. No.: 14/276,236

(22) Filed: May 13, 2014

(30) Foreign Application Priority Data
May 14, 2013 (EP) 13167690.0

(51) Int. Cl. B65G 17/12

(52) U.S. Cl. CPC B65G 17/12
USPC 198/469.1

(57) ABSTRACT

The invention proceeds from an apparatus for transporting, or for transporting and processing, printed circuit boards, having at least one transporting unit, which is provided for upright conveying purposes and has at least one wraparound conveyor means. It is proposed for the wraparound conveyor means to have at least one transporting bearing surface for supporting the printed circuit boards at least during transportation.

### CROSS REFERENCE TO RELATED APPLICATION

This application is based on and incorporates herein by reference European Patent Application No. 13167890.0 filed on May 14, 2013.

### PRIOR ART

The invention relates to an apparatus for transporting, or for transporting and for processing, printed circuit boards according to the preamble of claim 1.

WO 92/21451 A1 has already proposed an apparatus for transporting, or for transporting and for processing, printed circuit boards which comprises a transporting unit which is provided for upright conveying purposes and comprises a wraparound conveyor.

It is an object of the invention, in particular, to provide an apparatus of the type in question which has improved properties in respect of a compact transporting-unit configuration and in respect of printed circuit boards being subjected to only a low level of loading during transportation. The object is achieved according to the invention by the features of patent claim 1, whereas, advantageous configurations and developments of the invention can be gathered from the dependent claims.

### Advantages of the Invention

The invention proceeds from an apparatus for transporting, or for transporting and for processing, printed circuit boards, having at least one transporting unit which is provided for upright conveying purposes and has at least one wraparound conveyor.

It is proposed for the wraparound conveyor to have at least one transporting bearing surface for supporting the printed circuit boards at least during transportation. The expression “upright conveying” here is intended to define, in particular, an operation in which printed circuit boards are conveyed in a transporting direction of the transporting unit and in which the element is oriented vertically during transportation. “Oriented vertically” here is intended to be understood, in particular, as an orientation of the printed circuit board in which the main plane of extent of the printed circuit board is oriented at least essentially perpendicularly to a floor-contact surface of the apparatus. The expression “floor-contact surface” here is intended to define, in particular, a surface of the apparatus which allows the apparatus to be set down on an underlying surface. The floor-contact surface is preferably formed by a surface of a stand of the apparatus, in particular of a stand of a carrying-frame unit of the apparatus. The expression “essentially perpendicularly” here is intended to define, in particular, an orientation of a direction relative to a reference direction, wherein the direction and the reference direction, in particular as seen in a single plane, enclose an angle of 90° and the angle has a maximum deviation of, in particular, less than 8°, advantageously less than 5° and particularly advantageously less than 2°.

A “wraparound conveyor” here is intended to be understood, in particular, as an element which, for the purpose of transmitting drive forces, at least partially wraps around a drive element, in particular a drive wheel, and can thus be driven by the drive element. The wraparound conveyor here may be embodied as a transporting belt, transporting chain, etc. The expression “transporting bearing surface” here is intended to define, in particular, a surface of the wraparound conveyor which is provided, for the purpose of transmitting transporting forces, in order to butt directly against the printed circuit boards. The transporting bearing surface here may be formed by a single, in particular planar, surface which is oriented at least essentially transversely to an upright axis of the transporting unit. It is also conceivable, however, for the transporting bearing surface to be made up of a plurality of sub-surfaces which run at least essentially transversely to one another, for example are angled in relation to one another, etc. It is thus possible to form, for example, a V-shaped transporting bearing surface or the like. Further configurations of the transporting bearing surface which appear to be expedient to a person skilled in the art are likewise conceivable. The transporting bearing surface particularly preferably runs at least essentially transversely to the upright axis of the transporting unit. “Essentially transversely” here is intended to be understood, in particular, as an orientation of a direction and/or of an axis relative to a reference direction and/or a reference axis, wherein the orientation of the direction and/or of the axis is at least different from an at least essentially parallel orientation to the reference direction and/or to the reference axis and, in particular, is inclined or perpendicular to the reference direction and/or to the reference axis. “Upright axis” here is intended to be understood, in particular, as an axis of the transporting unit which is oriented at least essentially perpendicularly to the floor-contact surface of the apparatus. The upright axis of the transporting unit is preferably in the form of a vertical axis. The configuration of the

apparatus according to the invention advantageously makes it possible for the printed circuit boards to be conveyed in a manner which does not adversely affect the components. It is advantageously possible for the printed circuit boards to be subjected to only a low level of bending during transportation of the printed circuit board by means of the apparatus according to the invention. In addition, upright conveying advantageously makes it possible to avoid, advantageously at least for the most part, permanent deformation of the printed circuit board during transportation. Furthermore, the upright conveying advantageously makes it possible to avoid contamination of the printed circuit board, for example by dust or by swarf as result of coming into contact with contact-needle elements, during transportation. It is also advantageously possible to do away with components for transmitting transporting forces. It is thus advantageously possible to realize a compact transporting unit and/or a compact apparatus.

Furthermore, it is proposed for the transporting bearing surface to run at least essentially perpendicularly to the upright axis. For the purpose of driving the wraparound conveyor, the transporting unit comprises at least one drive unit which comprises at least one drive wheel, around which the wraparound conveyor wraps at least partially. In addition, the drive unit may comprise supporting rollers, tensioning rollers, etc., which are provided in order to support and/or to tension the wraparound conveyor at least during a transporting movement. The configuration according to the invention advantageously makes it possible to achieve a compact configuration of the apparatus according to the invention. In addition, it is advantageously possible to realize a large transporting bearing surface, by means of which the printed circuit board can be transported and guided.

It is also proposed for the wraparound conveyor to be embodied as a transporting belt which has a polygonal cross section. The wraparound conveyor here is preferably of endless design or has a continuous progression. The transporting belt particularly preferably comprises a rectangular or quadrilateral cross section. It is also conceivable, however, for the transporting belt to have a pentagonal cross section, which forms a V-shaped holder at least on one side. Further configurations which appear to be expedient to a person skilled in the art are likewise conceivable. It is also possible for the transporting unit to have at least one supporting element which, as seen along the upright axis, at least partially covers over the wraparound conveyor, embodied as a transporting belt. It is advantageously possible to achieve a guide surface in the region of the wraparound conveyor, embodied as a transporting belt. It is additionally possible for the wraparound conveyor, embodied as a transporting belt, to be protected against contamination. It is conceivable here for the supporting element to have arranged on it a dirt-repeller element, for example a rubber lip, which can thus reduce, or for the most part avoid, contamination of the wraparound conveyor, embodied as a transporting belt. The configuration according to the invention can advantageously achieve a flat construction of the transporting unit, in particular of the wraparound conveyor.

In addition, it is proposed for the transporting unit to have at least one transporting and/or guide element which is embodied as a guide rail. The wraparound conveyor and the transporting and/or guide element here are spaced apart relative to one another preferably along the upright axis. For the purpose of transporting the printed circuit boards, the printed circuit boards, as seen along the upright axis, are arranged preferably between the wraparound conveyor and the transporting and/or guide element. It is thus the case that the printed circuit boards, during transportation in the transporting direction, butt preferably at least partially against the wraparound conveyor and partially against the transporting and/or guide element. The transporting and/or guide element, embodied as a guide rail, preferably comprises at least one supporting and/or transporting surface. The supporting and/or transporting surface is particularly preferably provided in order to subject the printed circuit boards to at least one supporting and/or retaining force of which the main force component runs at least essentially parallel to the upright axis. “Essentially parallel” here is intended to be understood, in particular, as an orientation of a direction relative to a reference direction, in particular in a single plane, wherein the direction in relation to the reference direction has a deviation, in particular, less than 8°, advantageously less than 5° and particularly advantageously less than 2°. The expression “main force component” here is intended to define, in particular, a force component, in particular a vectorial force component, which makes up the greatest percentage fraction of the force. In particular more than 40%, preferably more than 50% and particularly preferably more than 65%, of the supporting and/or retaining force acts on the printed circuit board, with the latter in at least a state in which it is arranged between the transporting and/or guide element and the wraparound conveyor, in a direction which runs at least essentially transversely to the upright axis, in particular as the printed circuit boards are being transported or retained, it is preferably possible for the transporting and/or guide element and the wraparound conveyor to be adjusted in position relative to one another. It is possible here for the transporting and/or guide element and the wraparound conveyor to be adjusted in position relative to one another in a stepless or in a stepwise manner. For the purpose of arresting the transporting and/or guide element and the wraparound conveyor in position relative to one another, the apparatus here preferably comprises at least one arresting unit, which is provided in order to arrest the transporting and/or guide element and the wraparound conveyor in position by means of a form-fitting and/or by means of a force-fitting connection. The arresting unit here may be formed by in one piece with an adjusting unit for adjusting a position of the transporting and/or guide element and of the wraparound conveyor. It is therefore the case that the transporting unit can preferably be adjusted to different sizes and formats of printed circuit board. The configuration according to the invention can achieve particularly advantageous handling of printed circuit boards by means of the apparatus according to the invention.

Furthermore, it is proposed for the transporting and/or guide element, which is embodied as a guide rail, is movably supported, relative to the wraparound conveyor, along a movement axis which runs at least essentially parallel to the upright axis. The transporting and/or guide element, embodied as a guide rail, is preferably fixed to the frame of a carrying-frame element of the transporting unit. The carrying-frame element itself, however, is preferably movably supported relative to further components, in particular relative to a main frame, of the transporting unit. It is thus the case that the transporting and/or guide element, which is embodied as a guide rail, is preferentially movably supported, relative to the wraparound conveyor, at a main frame of the transporting unit by means of the carrying-frame element of the transporting unit. The configuration according to the invention advantageously allows for precise orientation of the printed circuit boards during transportation in the transporting direction of the transporting unit. It is thus advantageously possible for printed circuit boards to be conveyed in a space-saving manner. It is additionally possible, in particular in an advantageous manner, for the printed circuit boards to be precisely accommodated and transferred to further operating stations of the apparatus according to the invention.

It is also proposed for the transporting and/or guide element, embodied as a guide rail, to comprise at least one guide groove, in which the printed circuit boards are guided at least during transportation. It is particularly preferable here for the supporting and/or transporting surface of the guide and/or transporting element, embodied as a guide rail, to butt directly against the printed circuit boards for the purpose of guiding the printed circuit boards during transportation. The supporting and/or transporting surface of the guide and/or transporting element, embodied as a guide rail, preferably butts directly against a surface of the printed circuit boards which runs at least essentially perpendicularly to a main plane of extent of the printed circuit boards or against a transition edge between that surface of the printed circuit boards which runs at least essentially perpendicularly to a main plane of extent of the printed circuit boards and a surface of the printed circuit boards which runs at least essentially parallel to the main plane of extent. A “main plane of extent” here is intended to be understood, in particular, as a plane of the printed circuit boards in which the printed circuit boards have a maximum extent. The guide and/or transporting element is preferably embodied as an upper guide and/or transporting element, whereas the wraparound conveyor is preferably embodied as a lower guide and/or transporting element. At least the supporting and/or transporting surface of the guide and/or transporting element, embodied as a guide rail, is preferably formed from a friction-reducing material or provided with a friction-reducing layer. The supporting and/or transporting surface is preferably formed by a surface of the transporting and/or guide element, embodied as a guide rail, which bounds a guide groove of the transporting and/or guide element. The guide groove of the transporting and/or guide element, embodied as a guide rail, preferably has a U-shaped configuration.

In an alternative configuration of the apparatus according to the invention, it is conceivable for the transporting and/or guide element which is embodied as a guide rail, to have two supporting and/or transporting surfaces which are movably supported relative to one another. This makes it possible to adjust the supporting and/or transporting surfaces to at least one dimension, in particular a thickness, of the printed circuit boards. In particular, the guide groove, as seen in a direction which runs at least essentially perpendicularly to the upright axis, has an accommodating width which is less than 10 mm, preferably less than 8 mm and particularly preferably less than 6 mm. The groove, as seen in a direction which runs at least essentially perpendicularly to the upright axis, preferably has an accommodating width which has a value between 0.2 mm and 8 mm. The configuration according to the invention advantageously makes it possible for the printed circuit boards to be guided reliably during transportation. It is advantageously possible to prevent the situation where the printed circuit boards tilt, or drop, in an undesired manner out of the transporting and/or guide element. The configuration according to the invention particularly advantageously makes it possible for the printed circuit boards to be guided precisely during transportation. It is therefore the case that the printed circuit boards can advantageously be arranged in a stable manner in order to be transported and/or processed.

In addition, it is proposed for the apparatus to comprise at least one linear-movement unit, which is provided to translatorically movably support at least one portion of the transporting unit along a linear-movement axis. The linear-movement axis particularly preferably runs at least essentially perpendicularly to the upright axis. In addition, the linear-movement axis preferably runs at least essentially perpendicularly to the transporting direction of the transporting unit. The configuration according to the invention can advantageously provide for a diverter function, for example for the purpose of separating out printed circuit boards or of connecting two parallel transporting-route portions of the transporting unit.

Furthermore, it is proposed for the apparatus to comprise at least one pivoting unit, which is provided in order to support at least one portion of the transporting unit in a pivotable manner about a pivot axis. The pivot axis here can run at least essentially parallel and/or at least essentially perpendicularly to the upright axis. The configuration of the apparatus according to the invention can advantageously provide for a high level of flexibility in respect of the operations of feeding and/or transporting printed circuit boards. For example, as a result of a portion or of a sub-region of the transporting unit being pivoted about a pivot axis which runs at least essentially perpendicularly to the upright axis, it is possible to provide for printed circuit boards being set down, following transportation, in a horizontal storage magazine, etc.

It is also proposed for the apparatus to comprise at least one upright checking unit to which the printed circuit boards can be fed in an upright state by means of the transporting unit, and by means of which the printed circuit boards can be checked in an upright position. A movement direction in which checking elements of the upright checking unit can be moved preferably runs at least essentially perpendicularly to the upright axis. Provision can advantageously be made for printed circuit boards to be checked in a small amount of installation space. In addition, it is advantageously possible for a degree of contamination of printed circuit boards which could influence checking results to be kept as low as possible, since the upright orientation of the printed circuit boards can advantageously keep to a low level the adhesion or accumulation of particles of dirt in a region which is to be checked, in particular in combination with the supporting and/or transporting surface of the transporting and/or guide element, it is advantageously possible to achieve stable positioning for the purpose of checking the printed circuit board. In addition, upright checking of the printed circuit boards can keep the risk of a short circuit as a result of metal swarf to an advantageously low level, since the metal swarf cannot accumulate on the printed circuit boards which are to be checked.

In addition, it is proposed for the apparatus to comprise at least one upright populating unit, to which the printed circuit boards can be fed in an upright state by means of the transporting unit and by means of which the printed circuit boards can be populated in an upright position. A movement direction in which populating elements of the upright populating unit can be moved preferably runs at least essentially perpendicularly to the upright axis. Provision can advantageously be made for printed circuit boards to be populated in a small amount of installation space. In addition, it is advantageously possible for a degree of contamination of printed circuit boards which could influence population to be kept as low as possible, since the upright orientation of the printed circuit boards can advantageously keep to a low level the adhesion or accumulation of particles of dirt in a region which is to be populated. In particular in combination with the supporting and/or transporting surface of the transporting and/or guide element, it is advantageously possible to achieve stable positioning for the purpose of populating the printed circuit boards.

The apparatus according to the invention here is not intended to be restricted to the embodiment and use described above. In particular it is possible for the apparatus according to the invention, for the purpose of performing a function described herein, to have a number of individual elements, components and units which differs from a number thereof which is indicated herein.

### DRAWINGS

Further advantages can be gathered from the following description of the drawings. The drawings illustrate an exemplary embodiment of the invention. The drawings, the description and the claims contain numerous features in combination. A person skilled in the art will expediently also look at the features individually and combine them to form further appropriate combinations.

In the drawings:

FIG. 1 shows a schematic illustration of an apparatus according to the invention,

FIG. 2 shows a schematic illustration of a detail-form view of a transporting unit and of an upright checking unit, connected to the transporting unit, of the apparatus according to the invention,

FIG. 3 shows a schematic illustration of a further detail-form view of the upright checking unit,

FIG. 4 shows a schematic illustration of a detail-form view of the transporting unit of the apparatus according to the invention,

FIG. 5 shows a schematic illustration of a detail-form view of a pivoting unit of the apparatus according to the invention,

FIG. 6 shows a schematic illustration of a detail-form view of the pivoting unit together with a linear-movement unit of the apparatus according to the invention, and

FIG. 7 shows a schematic illustration of a detail-form view of a wraparound conveyor of the transporting unit.

### DESCRIPTION OF THE EXEMPLARY EMBODIMENT

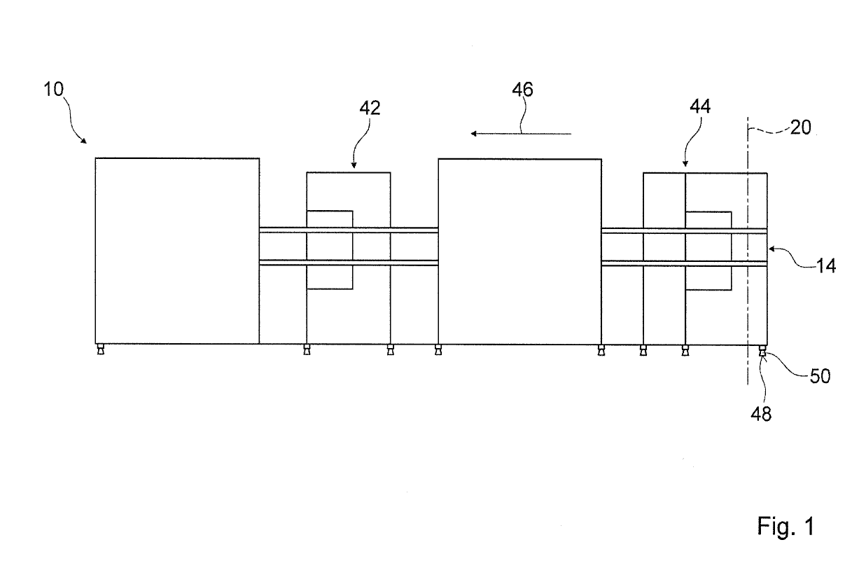

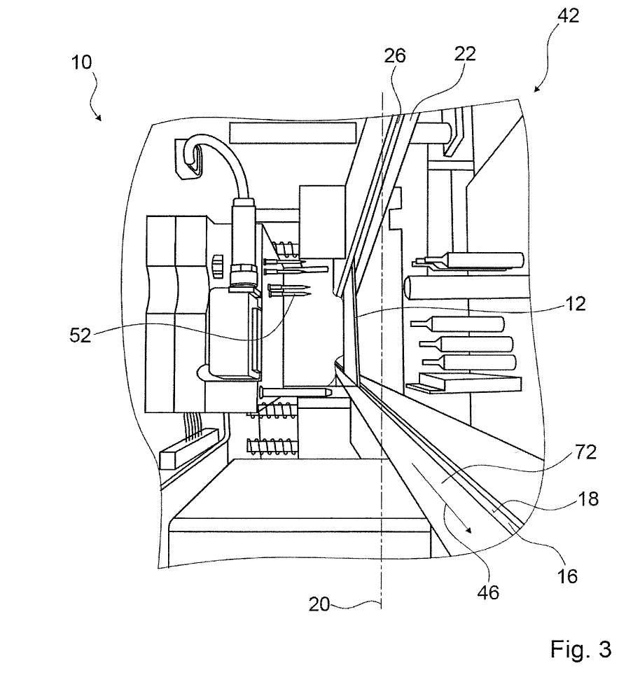

FIG. 1 shows an apparatus 10 for transporting, or for transporting and for processing, printed circuit boards 12. The figures illustrate just a single printed circuit board 12 in each case, for the purpose of explaining the functions of the apparatus 10. The apparatus 10 comprises various operating stations, in which the printed circuit boards 12 are, for example, populated, checked and/or cleaned. The apparatus 10 is thus embodied as a printed-circuit-board apparatus. The individual operating stations, for the apparatus 10, are embodied as an upright populating unit 44 and of an upright checking unit 42. It is also conceivable, however, for the apparatus 10 to have as an alternative, or in addition, further operating stations, for example an upright cleaning unit, which is arranged in a transporting direction 48 of the transporting unit 14 between the upright populating unit 44 and the upright checking unit 42, etc. The upright populating unit 44 is used to populate the printed circuit boards 12 with electronic components. With the exception of a vertical orientation of the upright populating unit 44, the operation of populating the printed circuit boards 12 here takes place at least essentially in a manner which is already known to a person skilled in the art. The populated printed circuit boards 12 are fed to a checking device of the upright checking unit 42, in which the printed circuit boards 12 are checked for functionality. Contact-needle elements 52 (cf. FIG. 3) of the upright checking unit 42 here are brought into contact with the individual printed circuit boards 12, in order to allow the printed circuit boards 12 to be checked for functionality. The contact-needle elements 52 here are moved in a direction which runs at least essentially perpendicularly to the upright axis 20 of a transporting unit 14 of the

apparatus 10. With the exception of a vertical orientation of the upright checking unit 42, a checking operation here takes place at least essentially in a manner which is already known to a person skilled in the art. The upright populating unit 44 and the upright checking unit 42 are arranged one behind the other in the transporting direction 48 of the transporting unit 14. it is also conceivable, however, for the upright populating unit 44 and the upright checking unit 42 to be arranged relative to one another in some other manner which appears to be expedient to a person skilled in the art.

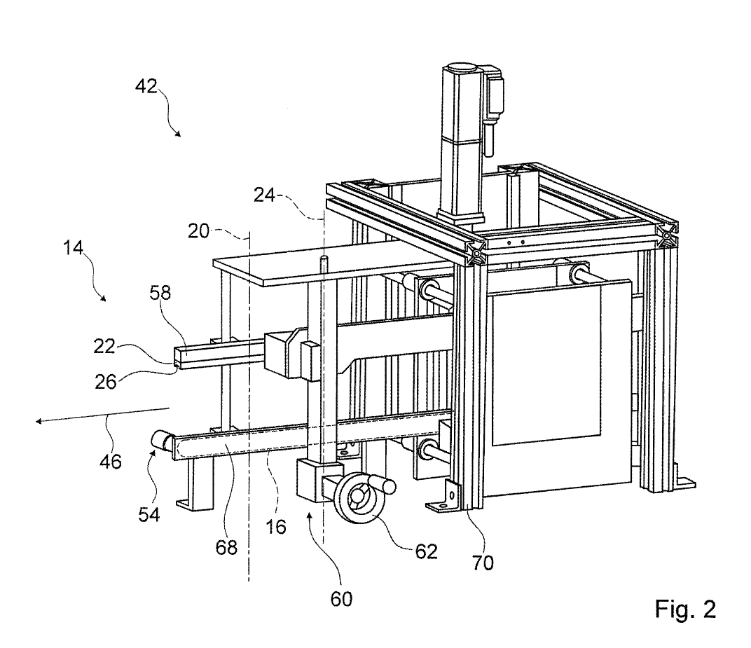

For the purpose of feeding the printed circuit boards 12 to the individual operating stations, the apparatus 10 comprises at least the transporting unit 14, which is provided for upright conveying purposes and has at least one wraparound conveyor means 16 (cf. FIGS. 2 and 7). The printed circuit boards 12 are thus transported in the transporting direction 46 of the transporting unit 14 in a vertically oriented state by means of the transporting unit 14. For this purpose, the wraparound conveyor means 16 has at least one transporting bearing surface 18 for supporting the printed circuit boards 12 at least during transportation. The transporting bearing surface 18 runs at least essentially perpendicularly to the upright axis 20 of the transporting unit 14. The upright axis 20 is oriented at least essentially perpendicularly to a floor-contact surface 48 of the apparatus 10. The floor-contact surface 48 is formed by a surface at least of a stand 50 of the apparatus 10.

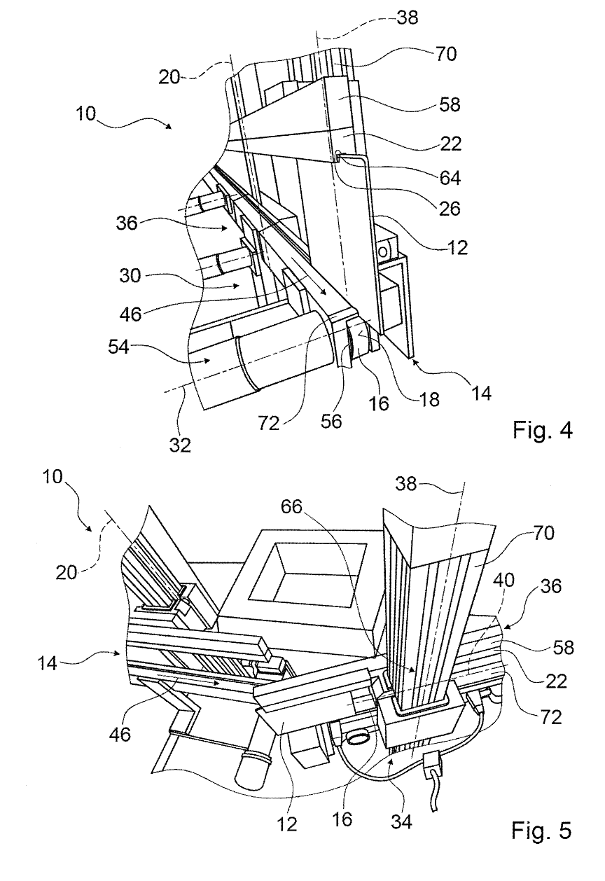

The wraparound conveyor means 18 is embodied as a transporting belt which has a polygonal cross section. The wraparound conveyor means 16 here may have longitudinal channels for guiding and/or for accommodating the printed circuit boards 12, or other guide-surface and/or accommodating-surface structures which appear to be expedient to a person skilled in the art. It is also conceivable, however, for the wraparound conveyor means 18, embodied as a transporting belt, to have an at least essentially planar surface structure. The wraparound conveyor means 16 is arranged on a carrying-frame element 68 of the transporting unit 14. The carrying-frame element 68 here is arranged at a fixed location on a main frame element 70 of the transporting unit 14, A main direction of extent of the carrying-frame element 68 here runs at least essentially perpendicularly to the upright axis 20 of the transporting unit 14, For the purpose of driving the wraparound conveyor means 16, the apparatus 10 has at least one drive unit 54 (cf. FIG. 2). The drive unit 54 is embodied as an electric-motor unit. It is also conceivable, however, for the drive unit 54 to be of some other configuration which appears to be expedient to a person skilled in the art, for example to be configured in the form of a hydraulic-motor unit, etc. The drive unit 54 comprises at least one drive wheel 56, around which the wraparound conveyor means 16 wraps at least partially (cf. FIGS. 4 and 7). The drive wheel 56 herein is supported in a rotatable manner on the carrying-frame element 68. Also arranged on the carrying-frame element 68 is at least one supporting element 72 of the transporting unit 14, said supporting element at least partially covering over the wraparound conveyor means 16, embodied as a transporting belt, as seen along the upright axis 20. The supporting element 72, in addition, forms a lateral guide surface in the region of the wraparound conveyor means 18, embodied as a transporting belt, it being possible for the printed circuit boards 12 to be guided on said guide surface during transportation. The guide surface of the supporting element 72 here extends at least essentially parallel to the upright axis 20 and to the transporting direction 48. The transporting unit 14, along an entire transporting route, comprises a multiplicity of individual portions 30, 38 or transporting sub-units, which each individually comprise a wraparound conveyor means 16, which can be driven by means of a drive unit 54 of the respective portions 30, 36 of the transporting unit 14.

For the purpose of conveying the printed circuit boards 12 in an upright state, the transporting unit 14, in addition to the wraparound conveyor means 16, comprises at least one transporting and/or guide element 22 which is embodied as a guide rail (cf. FIGS. 2 to 4). The portions 30, 36 or transporting sub-units of the transporting unit 14 here each individually have a transporting and/or guide element 22 embodied as a guide rail. The transporting and/or guide element 22, embodied as a guide rail, is spaced apart relative to the wraparound conveyor means 16, as seen along the upright axis 20. For transportation purposes, the printed circuit boards 12 are thus arranged in a vertically oriented state between the wraparound conveyor means 16 and the transporting and/or guide element 22, embodied as a guide rail. The printed circuit boards 12 here each have one side butting against the wraparound conveyor means 16 and a further side butting against the transporting and/or guide element 22, embodied as a guide rail. For the purpose of adjusting a distance between the wraparound conveyor means 16 and the transporting and/or guide element 22, embodied as a guide rail, along the upright axis 20, the transporting and/or guide element 22 is arranged on a movably supported, further carrying-frame element 58 of the transporting unit 14. The further carrying-frame element 58 here is translatorically movably supported at the main frame element 70 along a movement axis 24 which runs at least essentially parallel to the upright axis 20. The apparatus 10 thus comprises at least one upright distance-adjusting unit 60 for adjusting a distance between the wraparound conveyor means 16 and a transporting and/or guide element 22, embodied as a guide rail, along the upright axis 20 (cf. FIG. 2). The upright distance-adjusting unit 60 has a spindle element (not illustrated specifically here) and an operating element 62, which acts on the spindle element, The operating element 62 is provided in order to drive the spindle element in rotation in a manner which is already known to a person skilled in the art, so as to change or adjust a distance between the wraparound conveyor means 16 and the transporting and/or guide element 22, embodied as a guide rail, along the upright axis 20. It is thus the case that the transporting and/or guide element 22, embodied as a guide rail, is movably supported, relative to the wraparound conveyor means 16, along the movement axis 24 which runs at least essentially parallel to the upright axis 20. In an alternative configuration of the upright distance-adjusting unit 60 (not illustrated here), the upright distance-adjusting unit 60 comprises an electric, pneumatic and/or hydraulic linear-drive unit, by means of which it is possible to adjust a distance between the wraparound conveyor means 18 and the transporting and/or guide element 22, embodied as a guide rail, along the upright axis 20.

The transporting and/or guide element 22, embodied as a guide rail, also comprises at least one guide groove 26, in which the printed circuit boards 12 are guided at least during transportation (cf. FIGS. 3 and 4). The guide groove 26 here has a U-shaped configuration. It is also conceivable, however, for the guide groove 28 to have some other configuration which appears to be expedient to a person skilled in the art, for example a V-shaped configuration, etc. In addition, the transporting and/or guide element 22, embodied as a guide rail, comprises at least one supporting and/or transporting surface 64. The supporting and/or transporting surface 64 is provided in order to subject the printed circuit boards 12 to at least one supporting and/or retaining force, of which the main force component runs at least essentially parallel to the upright axis 20. It is also conceivable, however, for the supporting and/or transporting surface 64 as an alternative, or in addition, to be provided in order to subject the printed circuit boards 12 to at least one supporting and/or retaining force of which the main force component runs at least essentially transversely to the upright axis 20. The supporting and/or transporting surface 64 of the transporting and/or guide element 22, embodied as a guide rail, is formed by a surface of the transporting and/or guide element 22, embodied as a guide rail, which bounds the guide groove 28. The transporting and/or guide element 22 here, embodied as a guide rail, is formed from a plastics material, it is also conceivable, however, for the transporting and/or guide element 22, embodied as a guide rail, to be formed from a metal.

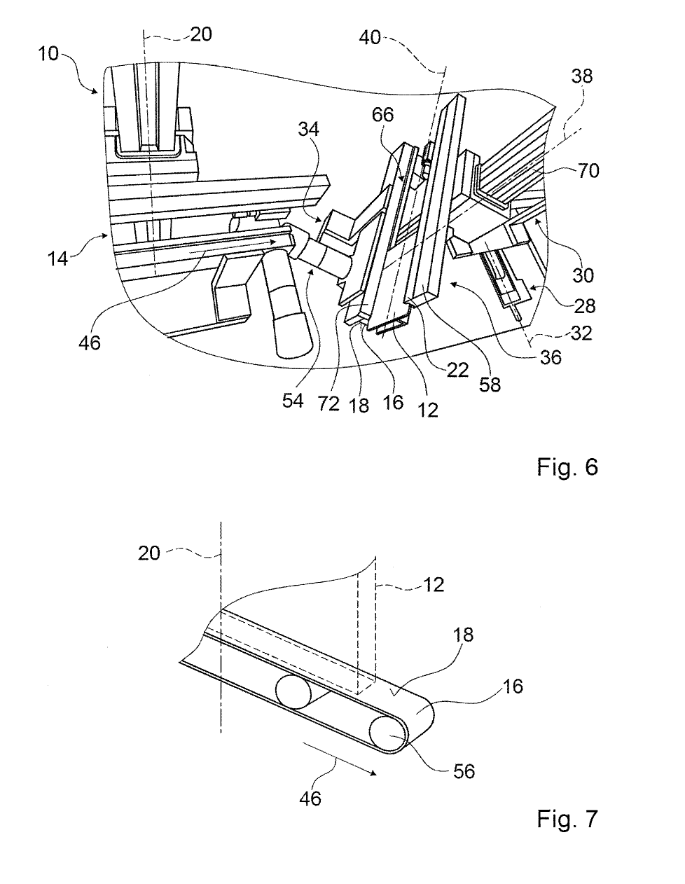

Furthermore, the apparatus 10 comprises at least one pivoting unit 34, which is provided in order to support at least one portion 38 of the transporting unit 14, or at least one transporting sub-unit of the transporting unit 14, in a pivotable manner about a pivot axis 38 (cf. FIGS. 5 and 6). The pivot axis 38 of the pivoting unit 34 here runs at least essentially parallel to the upright axis 20 of the transporting unit 14. In addition, the pivot axis 38 runs at least essentially transversely to the transporting direction 46 of the transporting unit 14. A pivoting movement of the portion 36 of the transporting unit 14, or of the transporting sub-unit of the transporting unit 14, makes it possible to deflect or branch off a transporting path of the printed circuit boards 12. The pivoting unit 34 is thus embodied as an upright axis-pivoting unit. A pivoting movement of the portion 36 of the transporting unit 14, or of the transporting sub-unit of the transporting unit 14, by means of the pivoting unit 34 is accompanied by a section of the transporting unit 14 on which are arranged at least one wraparound conveyor means 18 as described above, a transporting and/or guide element 22 as described above and a drive unit 54 as described above being pivoted about the pivot axis 38 relative to further portions of the transporting unit 14.

In addition to the pivoting unit 34, the apparatus 10 comprises a further pivoting unit 66. The further pivoting unit 66 is provided in order to support at least the portion 38 of the transporting unit 14, or at least the transporting sub-unit of the transporting unit 14, in a pivotable manner about a further pivot axis 40 (cf. FIGS. 5 and 6). The further pivot axis 40 here runs at least essentially perpendicularly to the upright axis 20 of the transporting unit 14. In addition, the further pivot axis 40 runs at least essentially transversely to the transporting direction 48 of the transporting unit 14. The further pivoting unit 66 is thus embodied as a flip-action pivoting unit, which is provided in order to pivot the printed circuit boards 12 out of a vertical orientation into a horizontal orientation, or vice versa. It is possible, for example, to remove printed circuit boards 12 from a horizontal storage magazine of the apparatus 10, and these printed circuit boards can be pivoted into a vertical orientation by means of the further pivoting unit 68, in order to make it possible for the printed circuit boards 12 to be transported in a vertical orientation by means of the transporting unit 14. A pivoting movement of the portion 38 of the transporting unit 14, or of the transporting sub-unit of the transporting unit 14, by means of the further pivoting unit 66 is accompanied by a section of the transporting unit 14 on which are arranged at least one wraparound conveyor means 16 as described above, a transporting and/or guide element 22 as described above and a drive unit 54 as described above being pivoted about the further pivot axis 40 relative to further portions of the transporting unit 14.

Furthermore, the apparatus 10 comprises at least one linear-movement unit 28, which is provided in order to translatorically support at least one further portion 30 of the transporting unit 14, or at least one further transporting sub-unit of the transporting unit 14, along a linear-movement axis 32. The linear-movement axis 32 here runs at least essentially perpendicularly to the upright axis 20 of the transporting unit 14. In addition, the linear-movement axis 32 runs at least essentially transversely and in particular perpendicularly to the transporting direction 46 of the transporting unit 14. The linear-movement unit 28 is thus embodied as a parallel-offsetting unit, which is provided in order to offset at least the further portion 30 of the transporting unit 14, or at least the further transporting sub-unit of the transporting unit 14, parallel relative, for example, to the portion 36 of the transporting unit 14, or of the transporting sub-unit of the transporting unit 14, in order to make it possible for example for two parallel transporting routes to be connected to one another or for the printed circuit boards 12 to be transferred between two parallel transporting routes. A translatory movement of the further portion 30 of the transporting unit 14, or of the transporting sub-unit of the transporting unit 14, by means of the linear-movement unit 28 is accompanied by a section of the transporting unit 14 on which are arranged at least one wraparound conveyor means 16 as described above, a transporting and/or guide element 22 as described above and a drive unit 54 as described above being moved in a translatory manner along the linear-movement axis 32 relative to further portions of the transporting unit 14.

The printed circuit boards 12 can be fed in an upright state to the upright populating unit 44 by means of the transporting unit 14. The printed circuit boards 12, as already described above, can be populated in an upright position in the upright populating unit 44. In addition, the printed circuit boards 12 can be fed in an upright state to the upright checking unit 42 by means of the transporting unit 14. The printed circuit boards 12, as already described above, can be checked in an upright position in the upright checking unit 42. The apparatus 10 therefore requires only a small amount of space in a production facility in order to transport, or transport and process, printed circuit boards 12.

1. An apparatus for transporting, or for transporting and for processing, printed circuit boards, comprising at least one transporting unit which is provided for upright conveying purposes and has at least one wraparound conveyor means, wherein the wraparound conveyor means has at least one transporting bearing surface for supporting the printed circuit boards at least during transportation.

2. The apparatus according to claim 1, wherein the transporting bearing surface runs at least essentially perpendicularly to an upright axis of the transporting unit.

3. The apparatus according to claim 1, wherein the wraparound conveyor means is embodied as a transporting belt which has a polygonal cross section.

4. The apparatus according to claim 1, wherein the transporting unit has at least one transporting and/or guide element which is embodied as a guide rail.

5. The apparatus according to claim 4, wherein the transporting and/or guide element, which is embodied as a guide rail, is movably supported, relative to the wraparound conveyor means, along a movement axis which runs at least essentially parallel to the upright axis.

6. The apparatus at least according to claim 4, wherein the transporting and/or guide element, which is embodied as a guide rail, comprises at least one guide groove, in which the printed circuit boards are guided at least during transportation.

7. The apparatus according to claim 1, further comprising at least one linear-movement unit, which is provided in order to translatorically movably support at least one portion of the transporting unit along a linear-movement axis.

8. The apparatus according to claim 1, further comprising at least one pivoting unit, which is provided in order to support at least one portion of the transporting unit in a pivotable manner about a pivot axis.

9. The apparatus according to claim 1, further comprising at least one upright checking unit, to which the printed circuit boards can be fed in an upright state by means of the transporting unit and by means of which the printed circuit boards can be checked in an upright position.

10. The apparatus according to claim 1, further comprising at least one upright populating unit, to which the printed circuit boards can be fed in an upright state by means of the transporting unit and by means of which the printed circuit boards can be populated in an upright position.
